(19) United States
(12) Patent Application Publication
(10) Pub. No.: US 2014/0156385 A1
(43) Pub. Date: Jun. 5, 2014

(54) MEASURING RECOLLECTION OF AN ADVERTISEMENT BY GROUPS OF USERS

(71) Applicant: Facebook, Inc., Menlo Park, CA (US)

(72) Inventors: Brad Hopkins Smallwood, Palo Alto, CA (US); Sean Bruich, Palo Alto, CA (US)

(21) Appl. No.: 13/705,625

(22) Filed: Dec. 5, 2012

(51) Int. Cl. G06Q 30/02

(52) U.S. Cl. CPC G06Q 30/0245
USPC 705/14.44

(57) ABSTRACT

An ad publishing system measures the effectiveness of an advertisement by determining whether recipients of the advertisement recall receiving it. This measurement is accomplished by polling a subset of the recipients of the advertisement as to whether they recall receiving, viewing, or otherwise being exposed to the advertisement. The market segment characteristics of the recipients and the subset of recipients are accounted for to improve the relevance of the polling responses. Market segment characteristics are determined using information describing recipients such as demographic information, psychographic information, or other information identifying likes, dislikes, interests, consuming habits, personal connections, group affiliations, internet browsing history, and other similar information. The responses to the recall poll can be used to calculate an effectiveness score of the advertisement as a function of market segment, advertisement publisher platform, or other variables.

### BACKGROUND

The present disclosure relates generally to advertisements served by or through an advertising publishing system, and in particular measuring the recollection of an advertisement by groups of system users.

An advertisement publisher can increase its revenue and profitability through more effective or targeted advertising. This increase is because the targeted ads can be more valuable when perceived by consumers as more relevant, thereby increasing the ability of the ad to influence consumer action. That is, by serving more relevant ads, advertisers can increase the rate at which recipients of the ads are converted into to purchasers of the advertised goods or services.

Traditionally, the effectiveness of an advertisement is measured by indirect means. Examples of these traditional measurements include measuring the number of impressions (i.e., the number of times that an advertisement is shown to a viewer) as well as measuring the number of conversions (i.e., the number of times a user presented with an advertisement engages with the advertisement). However, the information provided by these indirect measurement means is limited to identifying whether the advertisement was seen by the recipient or was presented to the recipient. Merely being seen by the recipient is not necessarily an indication of how memorable the advertisement was or whether it actually influenced the actions of the consumer. Similarly, merely being presented to a user is no indication that the advertisement was actually viewed; content presented to a user can be partially or wholly beyond a viewing screen (colloquially referred to as “below the fold”) or obscured by other windows on a recipient's computing device.

### SUMMARY

Embodiments of the present disclosure include methods and systems for identifying recipients of an advertisement, and methods of systems for describing the population of recipients. This information, referred to below as “market segment” information can include, but is not limited to, demographic and psychographic characterizations of the advertisement recipients and of the population of which the recipients are members.

The market segment information can be stored in a recipient-specific profile that an advertisement profiling system can access. In one embodiment, the advertisement profiling system is a social networking system (“SNS”), and the recipients of the advertisement are users of the social networking system. However, the users need not be logged into the SNS or view an advertisement within the SNS. In another embodiment, the advertisement profiling system is any system that includes recipient-specific profiles that can be accessed for use with the advertisement profiling system. Regardless of the particular platform used, the system may be able to identify the recipients of the ad and access market segment information that describes the recipients individually. This individual recipient data of a plurality of recipients may be aggregated and analyzed to create a market segment profile of the population of recipients.

To determine whether the advertisement was effective, the system identifies a subset of the population of advertisement recipients wherein the subset has the same or approximately the same market segment profile as the entire population of recipients. The market segment profile is determined by aggregating the market segment profile of the recipients of the advertisement and selecting one or more characteristics of the population. The system also sends a poll to the subset of the recipient population requesting feedback on whether the recipients in the subset recall receiving or viewing the advertisement. Polling a subset of recipients having the same or approximately the same market segment characteristics is beneficial for receiving accurate and meaningful responses. Advertisements may then be targeted to populations having specific characteristics, as responses from a non-representative subset of recipients may not accurately reflect the true effectiveness of an advertisement.

An effectiveness score is then calculated based on the number of recipients recalling the advertisement. This effectiveness score may be segmented by the advertisement, the platform used to publish the advertisement, demographics, psychographics, and combinations of these. The effectiveness score can then be used as a planning tool to direct advertising to advertising systems, locations within a system, and/or recipients based, in part, on the effectiveness score.

### BRIEF DESCRIPTION OF THE DRAWINGS

FIG. 1 is a block diagram of a system environment for providing advertisements and determining whether recipients recall viewing the advertisement, in an embodiment.

FIG. 2 is a block diagram of a system architecture for a social networking system used in one example as an advertisement profiling system, in an embodiment.

FIG. 3 is a flow chart of a method for providing advertisements to recipients and determining whether recipients recall viewing the advertisement, in an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

Overview

Embodiments of the present disclosure include methods and systems for measuring the effectiveness of an advertisement by determining whether recipients of the advertisement recall receiving it. This measurement is accomplished by polling a subset of the recipients (or in some cases, all recipients) of the advertisement as to whether they recall receiving, viewing, or otherwise being exposed to the advertisement. Furthermore, to measure the effectiveness in the context of different audiences of an advertisement, embodiments described below identify the market segment characteristics of the population of recipients and then distribute the poll to a subset sharing the same or approximately the same market segment. Market segment characteristics are determined using information describing recipients such as demographic information, psychographic information, or other information identifying likes, dislikes, interests, consuming habits, personal connections, group affiliations, internet browsing history, and other similar information.

In some embodiments, the responses to the recall poll are used to calculate an effectiveness score. This score can be used to compare advertisement publishing platform effectiveness, advertisement effectiveness within particular market segments, advertisement targeting techniques, advertising campaigns, and other effectiveness features. Effectiveness scores for some or all of the foregoing examples can also be used as a planning tool for advertising strategies, identifying advertising techniques or platforms that are particularly effective among certain market segments. In one example of using the effectiveness score as a planning tool, advertising is directed to advertising systems, market segments, recipients, or even particular ad placement locations on a recipient device based on an algorithm that maximizes the effectiveness score for the ad.

System Environment and Example System Architecture

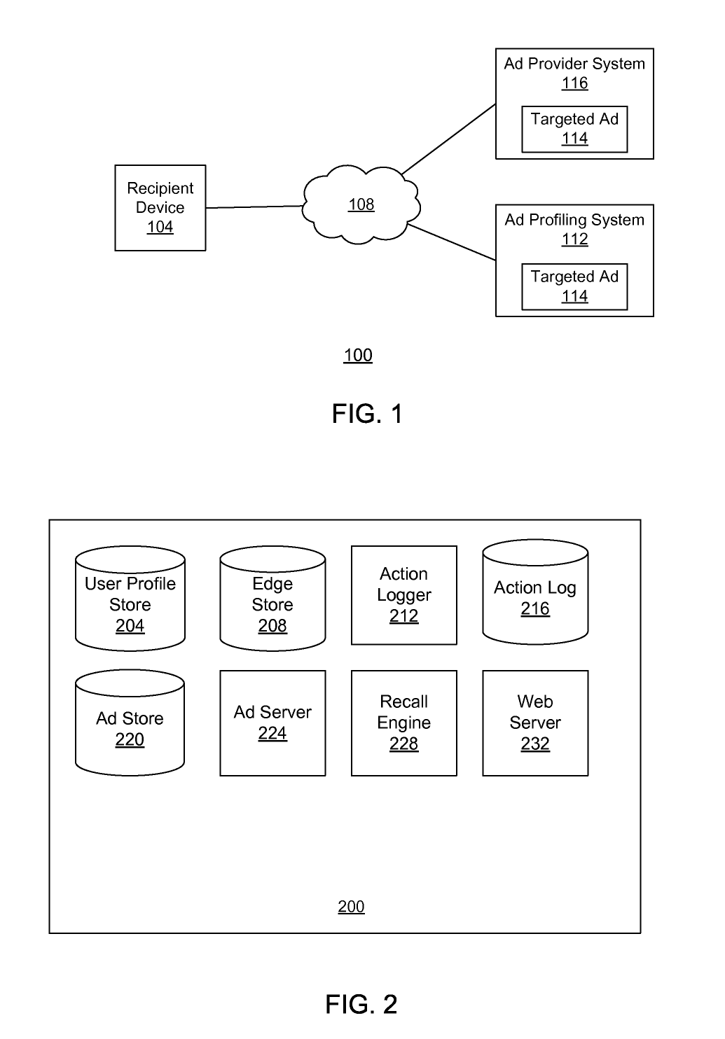

FIG. 1 is a block diagram of a system environment 100 for an advertisement (“ad”) profiling system 112. The system environment 100 shown in FIG. 1 includes a recipient device 104, a network 108, an ad profiling system 112, and an advertisement provider system 116. In other embodiments, the system environment 100 may include different and/or additional components than those shown by FIG. 1.

A recipient device 104 is a computing device capable of receiving user input as well as transmitting and/or receiving data via the network 108. In one embodiment, the recipient device 104 is a conventional computer system, such as a desktop or laptop computer. In another embodiment, the recipient device 104 may be a device having computer functionality, such as a personal digital assistant (PDA), mobile telephone, smart-phone or similar device. The recipient device 104 is configured to communicate with the ad profiling system 112 and/or the ad provider system 116 via the network 108. In one embodiment, the recipient device 104 executes an application allowing a user of the recipient device 104 to interact with the ad profiling system 112 and/or the ad provider system 116. For example, the recipient device 104 executes a browser application to enable interaction between the recipient device 104 and the ad profiling system 112 and/or the ad provider system 116 via the network 108. In another embodiment, a recipient device 104 interacts with the ad profiling system 112 and/or the ad provider system 116 through an application programming interface (API) that runs on the native operating system of the recipient device 104, such as IOS® or ANDROID™.

The recipient device 104 is configured to communicate via the network 108, which may comprise any combination of local area and/or wide area networks, using both wired and wireless communication systems. In one embodiment, the network 108 uses standard communications technologies and/or protocols. Thus, the network 108 may include links using technologies such as Ethernet, 802.11, worldwide interoperability for microwave access (WiMAX), 3G, 4G, CDMA, digital subscriber line (DSL), etc. Similarly, the networking protocols used on the network 108 may include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over the network 108 may be represented using technologies and/or formats including hypertext markup language (HTML) or extensible markup language (XML). In addition, all or some of links can be encrypted using conventional encryption technologies such as secure sockets layer (SSL), transport layer security (TLS), and Internet Protocol security (IPsec).

The ad profiling system 112 comprises one or more computing devices storing user profiles associated with users. In one embodiment, the ad profiling system 112 is a social networking system, further described below in conjunction with FIG. 2, which stores connections between users and other users and/or social network objects. Regardless of the configuration of the ad profiling system 112, users expressly or implicitly provide information to the ad profiling system 112, which records user identities and user information. The user identities and information can then be used to correlate or associate users with particular market segments. This market segment information includes, but is not limited to, demographic information (such as age, income bracket, ethnicity, gender, marital status, etc.) and psychographic information (shopping habits, hobbies, internet browsing habits, interests, etc.). As will be explained below, this market segment information is used in some embodiments to identify the effectiveness of an advertisement with respect to even narrow market segments using increasingly specific market segment information. This can provide a detailed picture of the relative effectiveness of an advertisement among different market segments.

In one embodiment, the ad provider system 116 includes systems that publish an advertisement to be accessible to the recipient device 104, and/or to tag an ad 114 with targeting criteria that corresponds to an intended market segment. In another embodiment, the ad provider system 116 transmits the ad 114 to the ad profiling system 112 through the network 108. In either case, the ad provider system 116 provides the ad 114 to recipient devices 104 or otherwise permits the recipient devices to access the ad, whether through a mobile application, a website, a social networking system, and/or the ad profiling system 112.

As mentioned above, one embodiment of the ad profiling system 112 includes a social networking system. One benefit of using a social networking system as an ad profiling system 112 is that the social networking system generates and maintains data regarding the preferences and habits of its users. These data often correspond to market segment information that can be used to determine the effectiveness of an advertisement for specific and/or narrowly defined market segments using the methods and systems described herein. The embodiments in which the ad profiling system 112 (and/or ad provider system 116) is a social networking system will be used as an example throughout this description, though this is just one example and the invention is not limited to this embodiment.

One way in which a social networking system generates and maintains detailed recipient (“user” in the case of the social networking system) market segment information is by generating and maintaining a “social graph” comprising a plurality of nodes interconnected by a plurality of edges. Each node in the social graph represents an object or user that can act on another node and/or that can be acted on by another node. An edge between two nodes in the social graph represents a particular kind of connection between the two nodes, which may result from an action that was performed by one of the nodes on the other node. For example, when a user of the social networking system identifies an additional user of the social networking system as a friend, an edge in the social graph is generated connecting a node representing the first user and an additional node representing the additional user. The generated edge has a connection type indicating that the users are friends. As various nodes interact with each other, the social networking system (even when used as an ad profiling system 112) modifies edges connecting the various nodes to reflect the interactions.

### Social Networking System Architecture

FIG. 2 is a block diagram of a system architecture of a social networking system 200 used as the ad profiling system 112. The social networking system 200, used as the ad profiling system 112, shown by FIG. 2 includes a user profile store 204, a edge store 208, an action logger 212, an action log 216, an ad store 220, an ad server 224, a recall engine 228, and a web server 232. In other embodiments, the social networking system 200 used as the ad profiling system 112 may include additional, fewer, or different modules for various applications. Conventional components such as network interfaces, security mechanisms, load balancers, failover servers, management and network operations consoles, and the like are not shown so as to not obscure the details of the system architecture.

Each user of the social networking system 200 is associated with a user profile, which is stored in the user profile store 204. A user profile includes declarative information about the user that was explicitly shared by the user, and may also include profile information inferred by the social networking system 200. In one embodiment, a user profile includes multiple data fields, each data field describing one or more attributes of the corresponding user of the social networking system 200. The user profile information stored in user profile store 204 describes the users of the social networking system 200, including biographic, psychographic, demographic, and other types of descriptive information, such as work experience, educational history, gender, hobbies or preferences, location and the like.

A user profile may also store other information provided by the user, for example, images or videos. In certain embodiments, images of users may be targeted with identification information of users of social networking system 200 displayed in an image. A user profile in the user profile store 204 may also maintain references to actions performed by the corresponding user performed on content items in the content store 208 and stored in the edge store 208.

The user profile may be used to associate the user with one or more market segments used for targeting an ad to the user and also used as part of the process to determine if the advertisement was effective, as described below in the context of the recall engine 228. For example, using the information stored in the user profile store 204, a user may be associated with market segments designating various combinations of the user's demographic and psychographic information. Two embodiments of the diversity of market segments for a user include, but are not limited to, men between the ages of 18 and 45 having an interest in golf, painting, and home maintenance; and women living in New Hampshire having an interest in wine and NASCAR racing, and working in the advertising industry. These two embodiments are provided only to illustrate the detailed nature of the information associated with each user in the user profile store 204, and the combinations possible to achieve increasingly detailed market segment information of the users.

Because the social networking system 200 generates and maintains data both expressly provided by users implied by activity of the users on the network 108, the combinations used to identify users as members of market segments is nearly limitless. However, a user may specify one or more privacy settings, which are stored in the user profile. These privacy settings limit information that the social networking system 200 is permitted to access or use for characterizing users as members of a market segment. For example, a privacy setting can limit the social networking system 200 to only expressly provided user profile information and can deny the system use of information suggested by internet browsing activity. As another example, a privacy setting limits the social networking system 200 to a user-defined subset of the edges and nodes maintained by the system.

In one embodiment, the edge store 208 stores the information describing connections between users and other objects on the social networking system 200 in edge objects. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system, such as expressing interest in a page on the social networking system 200, sharing a link with other users of the social networking system, and commenting on posts made by other users of the social networking system. The edge store 208 stores edge objects that include information about the edge, such as affinity scores for objects, interests, and other users.

Affinity scores may be computed by the social networking system 200 over time to approximate a user's affinity for an object, interest, market segment, and other users in the social networking system based on the actions performed by the user. Multiple interactions between a user and a specific object may be stored in one edge object in the edge store 208, in one embodiment. In some embodiments, connections between users may be stored in the user profile store 204, or the user profile store 204 may access the edge store 208 to determine connections between users.

As described above, the social networking system 200 can track user actions that can be used to identify users as part of a particular market segment. The action logger 212 receives information describing user actions on and/or off the social networking system 200, and populates the action log 216 with information about user actions. Actions stored in the action logger 212 may include, for example, adding a connection to another user, sending a message to another user, uploading an image, reading a message from another user, viewing content associated with another user, attending an event posted by another user, among others. In some embodiments, the action logger 212 receives, subject to one or more privacy settings, transaction information created by on line purchases or financial transactions performed by the user. This allows the action logger 212 to identify a user's purchases of products or services that are associated with a page of the social networking system 200, or another object, in the edge store 208. In addition, a number of actions described in connection with other objects are directed at particular users, so these actions are associated with those users as well. These actions are stored in the action log 216.

The action log 216 may be used by the social networking system 200 to track user actions on the social networking system 200, as well as external website that communicate information to the social networking system, further enriching the data characterizing users as part of one or more market segments. Users may interact with various objects on the social networking system 200, including commenting on posts, sharing links, and checking-in to physical locations via a mobile device, accessing content items in a sequence or other interactions. Information describing these actions is stored in the action log 216. Additional examples of interactions with objects on the social networking system 200 included in the action log 216 include commenting on a photo album, communications between users, becoming a fan of a musician, adding an event to a calendar, joining a groups, becoming a fan of a brand page, creating an event, authorizing an application, using an application and engaging in a transaction. Additionally, the action log 216 records a user's interactions with advertisements on the social networking system 200 as well as other applications operating on the social networking system. In some embodiments, data from the action log 216 is used to infer interests or preferences of the user, augmenting the interests included in the user profile and allowing a more complete understanding of user preferences.

Using the social networking system 200 as the ad profiling system 112 is beneficial because, as described above, users of the social networking system can be characterized using data generated and/or maintained by the social networking system that is both abundant and detailed. From expressly shared data, to internet browsing patterns, to social connections to other people, brands, and products, the data stored by the social networking system can be used to characterize users as part of one or more market segments. In part, this information can be used to target advertising, as described in, for example, U.S. patent application Ser. No. 12/195,321 (published as U.S. Publication No. 2009/0070219), incorporated herein by reference in its entirety. This information may also be used to analyze the effectiveness of an advertisement, as described below.

In one embodiment of the social networking system 200, the ad store 220 includes ads 114 provided to the social networking system by the ad provider system 116. The ad store 220 stores the ads, regardless of how they are provided, for serving by the ad server 224. In addition to the ad 114, in some embodiments the ad store 220 can also store information characterizing the ad. For example, the ad characterizing information can indicate the individuals or groups to whom the ad 114 should be targeted. In other examples, the characterizing information includes, but is not limited to, information describing the affinities of users to whom the ad should be targeted, other types of ad targeting criteria, ad bid information, ad provider information such social networking system 200 pages related to the ad provider, the number of impressions of the ad to be served, the targeted number of clicks per served impressions, and other related advertising logistical and/or sales information.

The ad server 224 receives instructions from the ad profiling system 112 to retrieve an ad 114 from the ad store 220 and publish the ad. As mentioned above, the ad server the ad 114 to the social networking system 200 for access by the recipient device 104. The ad 114 can be published so that it is available uniformly to any recipient device 104 that accesses a page (whether a webpage, a mobile app, etc.) on which the ad appears. This can be accomplished in one example by the ad server 224 providing the ad 114 to the ad provider system 116. The ad provider system 116 then publishes the ad 114 to a page, which then presents the ad uniformly to any recipient device 104 that subsequently accesses the page.

The ad 114 can also be provided to specific users based on targeting criteria supplied by the ad provider system 116 with the ad. For example, recipients of the ad 114 are identified by, first, using the ad server 224 to receive the targeting criteria of the ad from the ad store 220 and, second, using the ad server 224 to search the user profile store 204 and the action log 216 for market segment information of users that corresponds (in whole or in part) to the received targeting criteria. The identity of users having profiles that include market segment information corresponding to the targeting criteria is then received by the ad server 224. The ad server 224 then provides the ad to the recipient devices 104 of the identified users when the recipient device connects to a page through the network 108. In some examples, the page that is accessed by the recipient device 104 of the identified user calls the ad server 224 to populate a field with a targeted ad 114, although this is only one method of providing a targeted ad to a user.

In addition to providing the ad 114 for access by the recipient device 104, the ad server 224 also maintains a reference to the identity (or, alternatively, a user profile) of the recipient of the ad and a reference to the ad provided to the user. This recorded connection between the identity of the recipient, and the corresponding user profile of the recipient, and the ad served is then used by the recall engine 228 as part of its process for evaluating the effectiveness of an ad.

The recall engine 228 operates with various elements of the ad profiling system 112 to determine the effectiveness of an ad by measuring the recollection of users of having received the ad. In particular, the recall engine polls a subset of the population of users that received the ad, wherein the subset has the same or approximately the same market segment characteristics as the population of all recipients of the ad, thereby improving the validity of the effectiveness data particularly for ads targeted to specific market segments. In another embodiment, the recall engine does not necessarily poll the same market segment profile in the subset, but selects responses that match the market segment profile of the original recipients to achieve generally the same result.

While the following discussion is in the context of a social networking system 200, other ad profiling systems 112 may be used to determine the effectiveness of an ad using analogous methods of associating recipient identities with a received ad, and using market segment information of the recipients to poll a subset of the recipients as to their recollection or memory of receiving the ad 114. However, using the social networking system 200 as the ad profiling system 112 is particularly beneficial in this application: the richness of data stored in the user profile store 204 and the action log 216 enables a detailed characterization of ad recipients according one or more market segments.

The recall engine 228 determines the effectiveness of the ad 114 by polling a subset of the recipients of the ad as to their recollection of receiving the ad, where in one embodiment the subset has the same or approximately the same market segment characteristics as the plurality of recipients that received the ad. The benefit of this type of polling is that, particularly for a targeted ad 114, the responses to the poll are representative of the population of recipients, and not skewed toward a population of those responding to the poll. In another embodiment, rather than polling a subset with the same market segment characteristics, the recall engine 228 polls a subset (e.g., a first subset) without regard to whether the recipients in the subset have the same market segment characteristics, but the recall engine selects recipients with responses to the recall poll (e.g., a second subset) where the recipients in this subset have a second market segment profile that is the same or approximately the same as the first market segment profile.

To accomplish this effectiveness polling, the recall engine 228 queries the ad server 224 for the identities of a plurality of recipients of the ad 114. The recall engine 228 then determines a market segment profile of the plurality of recipients of the ad 114. The market segment profile can include any combination of the demographic characteristics, psychographic characteristics, or social objects stored in the user profile store 204, the edge store 208, and/or the action log 216 as described above. This profile then describes the collective market segment characteristics of the plurality of recipients of the advertisement, including even specifically defined market segments. For example, the profile can include the fraction of each gender, the distribution of ages for each gender, and the marital status of each age within each gender. In another example, the profile can include the geographic distribution of the ad 114 recipients, the income brackets within each geographic location, and the reading preferences of income bracket within each geographic location. As mentioned above, the diversity of combinations of characteristics and market segments is nearly limitless, particularly for cases in which the social networking system 200 is used as the ad profiling system 112.

Having determined the market segments of the recipients of the ad 114, which can be defined either in whole or in part by the market segments of interest to the ad provider, the recall engine selects a subset of recipients from the plurality of recipients. The subset of recipients is selected (or the subset of recipients responding is selected) to have the same or approximately the same market segment profile as the plurality of recipients. The recall engine then provides the recipients in the subset with a poll or questionnaire that inquires whether the users of the recipients in the subset recall receiving the ad 114. The recall engine then receives responses to the poll and calculates a recollection rate that is a function of the number of responses and an inverse function of the number of recipients in the plurality of recipients.

The responses of this poll are beneficial for determining the effectiveness of the advertisement because the poll is sent by the recall engine 228 to the subset that shares the same or approximately the same market segment characteristics as the plurality of recipients (or the recipients responding to the poll are selected to have the same/approximately the same market segment characteristics). By doing this, the responses to the poll are less likely to be influenced by respondents that are either not of interest to the ad provider or are not a targeted market segment of the ad. In situations where not all recipients in the subset respond, and the respondents as a group do not have the same or a approximately the same market segment profile as the plurality of respondents, the recall engine 228 can send additional polls to recipients in the plurality in order to match the market segment profile of the poll respondents to that of the plurality of recipients.

The recall poll can be provided by the recall engine 228 to recipients in the subset at a single time, or multiple times over the course of days, weeks, or months to measure the effectiveness of the ad 114 over the course to time. In one example, the recall poll is provided within 24 hours after the ad is provided. In another example, the recall poll is provided a week after the ad is provided. In yet another example, the recall both is provided both 24 hours and a week after the ad is provided in order to measure the persistence of the memory of the ad.

In addition to determining the effectiveness of the ad 114 over time, the recall poll provided by the recall engine 228 to the subset of recipients can be used to determine the effectiveness of a particular ad in diverse market segments, across diverse ad provider systems 116, and/or at a particular placement location on a recipient device 104. For example, the recall engine 228 can, after receiving responses from the subset of recipients, determine the effectiveness of the ad 114 among different sub-populations within the subset. In one embodiment, having received responses from a subset sharing a market segment profile with the plurality of recipients, the recall engine 228 can analyze whether sub-market segments (such as different age groups, genders, social networking system 200 group affiliations, etc.) within the subset have different recollections of the ad 114.

The recall engine 228 can also determine an effectiveness of an ad 114 provided through different ad provider systems 116 in order to determine the effectiveness of the combination of the ad and the provider system. For example, users may be more receptive to advertising when presented through the social networking system 200 compared to advertising presented as an ad on third party website. By polling the recipients receiving the ad through each of these provider systems 116 separately, an indication of the provider system effectiveness can be inferred. In some embodiments of this example, the market segment profile for each ad provider system 116 can optionally be kept constant. In another example, the effectiveness of a first third party website can be compared to the effectiveness of a second third party website.

In some embodiments, the recall engine 228 can calculate an effectiveness score that can be used to indicate the effectiveness of an ad 114. In one example, the number recipients of an ad 114 (often referred to as “reach” or “impression served”) can be multiplied by the fraction of respondents of the subset indicating a recollection of the ad. In another example, the foregoing effectiveness score can be normalized by the total reach or number of impressions served. As with examples described above, this type of effectiveness score can be calculated on a per ad provider system 116 basis, or per respondent market segment basis.

An ad provider may also use the effectiveness of the ad 114 as determined by the recall engine 228 as a planning tool. That is, responsive to determining that a particular ad provider system 116 (such as a first third-party website or the social networking system 200) has better response rates from the recipients in the subset, an ad provider can preferentially publish ads on that system 116. In another example, the better response rate can be identified for a particular ad 114 with respect to a particular market segment.

Furthermore, the effectiveness score can be used to direct ads to particular ad provider systems 116, websites, mobile applications, market segments and/or even placements within an advertising display based on an effectiveness score threshold or value, or relative performance compared to other systems, mobile applications, market segments, and/or placements. For example, an advertiser can establish criteria used to reallocate a distribution of advertising between a first ad provider system 116 and a second ad provider system 116 responsive to differing ad recall rates from the first and second ad provider systems. In one embodiment, this criterion can be applied dynamically so that ad impressions initially served to the first and the second systems 116 in a first ratio are shifted toward the ad provider system having a higher effectiveness score, thereby creating a second ratio of ad impressions served between the two systems.

In yet another embodiment, ad impressions can be served through the first ad provider system 116 as long as the effectiveness score is above a value (e.g., 20% of recipients recall being presented with the ad 114) or above a performance threshold relative to the performance of other ad provider systems (e.g., top three performing ad provider systems, top ten performing systems, top 10% of systems). In still another embodiment, the ad recall measurement can be used in cooperation with other measurements of ad distribution (e.g., reach as described above) to ensure that a number of people are not only presented with the ad 114, but also actually remember the ad. This can also be further applied to specific market segments to ensure that a number of people within one or more particular market segments are exposed to, and remember, the ad 114.

The web server 232 links the ad profiling system 112 and the ad provider system 116 to the recipient device 104 via the network 108. The web server 232 serves web pages, as well as other web-related content, such as JAVA®, FLASH®, XML and so forth. The web server 232 may provide the functionality of receiving and routing ads 114 and/or recall polls between the ad profiling system 112 and the recipient device 104, using for example, instant messages, queued messages (e.g., email), text and SMS (short message service) messages, or messages sent using any other suitable messaging technique. Additionally, the web server 232 may provide application programming interface (API) functionality to send data directly to native client device operating systems, such as IOS®, ANDROID™, WEBOS® or RIM. The web server 232 also provides API functionality for exchanging data between the ad profiling system 112, the ad provider system 116 and/or the recipient device 104.

### Determining the Effectiveness of an Advertisement

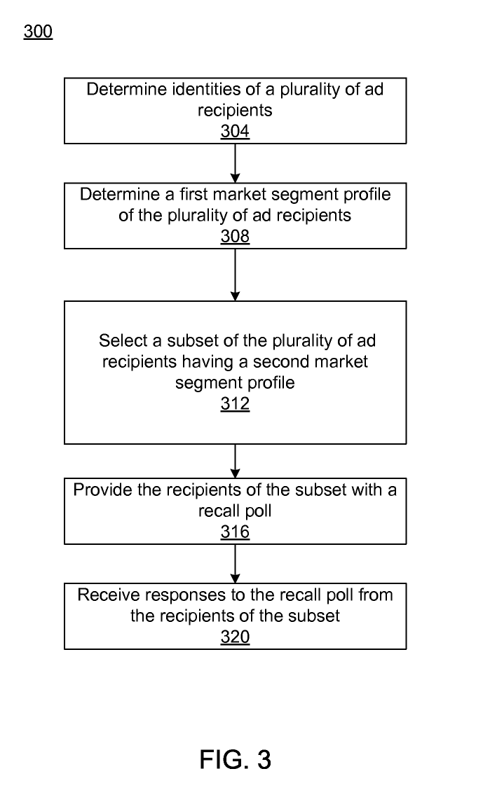

FIG. 3 is an example method 300 for determining an effectiveness of an ad provided in conjunction with an ad profiling system 112. As described above, the ad profiling system 112 determines 304 identities of a plurality of recipients of the ad. The recipient identities are associated with profiles that include market segment information. The market segment information includes demographic information (age, gender, income level, education level, etc.), psychographic information (hobbies, preferences, shopping habits), and in some cases, social connection information (connections to other recipients, social networking system groups, and connections to other social objects).

The profiles of the plurality of ad recipients are analyzed by the ad profiling system 112 to determine 308 a first market segment profile of the plurality of ad recipients. The first market segment profile can include some or all of the information stored in the recipient profiles and/or can be selected by an ad provider as a function of a targeted audience of the ad 114. As explained above, the market segment profile can include the fraction of each gender, an age distribution, an income distribution, an education level distribution, and other features stored in the recipient profile.

From the plurality of ad recipients, a subset of recipients is selected 312. In one embodiment, the subset has a second market segment profile that is the same or approximately the same as the first market segment profile characterizing the plurality of the recipients. In another embodiment, the subset (e.g., first subset) does not necessarily have the same market segment profile (e.g., has a different profile) than the first market segment profile. The recipients in the subset are provided 316 with a recall poll inquiring whether they recall receiving the ad. The responses to this recall poll are then received 320. In embodiments in which the subset (e.g., the first subset) did not have the same market segment profile, it is still possible to ensure accurate results tied to the appropriate market segment, since response to the recall poll can be selected to comprise a second subset, where the second subset has a second market segment profile that is the same as or substantially the same as the first market segment profile. In some examples, the responses are used to calculate an effectiveness score.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
determining identities of a plurality of recipients of an advertisement, each of the identities associated with a recipient profile including market segment information;
determining a first market segment profile of the plurality of recipients using market segment information in the recipient profiles;
selecting a subset of recipients from the plurality of recipients, the subset having a second market segment profile and selected based on a comparison of the first market segment profile with the second market segment profile;
providing each of the recipients in the subset with a recall question inquiring whether each of the recipients in the subset recalls the advertisement; and
receiving a response to the recall question from at least one of the recipients in the subset.

2. The method of claim 1, wherein the recall question is provided within 24 hours after the plurality of recipients has been provided with the advertisement.

3. The method of claim 1, further comprising determining an effectiveness score for the advertisement, the effectiveness score based on a number of recipients in the subset recalling the advertisement.

4. The method of claim 3, wherein the effectiveness score is calculated for each of at least two market segments of the plurality of recipients provided with the advertisement.

5. The method of claim 4, further comprising comparing a first effectiveness score of the advertisement for a first market segment to a second effectiveness score of the advertisement for a second market segment.

6. The method of claim 3, further comprising:
calculating an effectiveness score of the advertisement for each of at least two third-party websites providing the advertisement to recipients; and
comparing the effectiveness scores of the two third-party websites.

7. The method of claim 6, further comprising reallocating a distribution of advertising impressions served from a first third-party website having a first effectiveness score to a second third-party website having a second effectiveness score higher than the first effectiveness score.

8. The method of claim 3, wherein the effectiveness score is calculated by multiplying a total number of impressions of the advertisement served by a response rate of the subset to the recall question.

9. The method of claim 1, further comprising:
receiving the advertisement and a target audience of a defined demographic for the advertisement from an advertiser; and
using an effectiveness score for the defined demographic to further refine the target audience received from the advertiser.

10. The method of claim 1, further comprising using a social networking system to provide the advertisement for display.

11. The method of claim 1, wherein the market segment information comprises demographic information.

12. The method of claim 1, wherein the market segment information comprises psychographic information.

13. The method of claim 1, wherein the market segment information is based at least in part on whether the user has established one or more social connections with another object in the social networking system.

14. A method comprising:
determining identities of a plurality of recipients of an advertisement, each of the identities associated with a recipient profile including market segment information;
determining a first market segment profile of the plurality of recipients using market segment information in the recipient profiles;
selecting a first subset of recipients from the plurality of recipients;
providing each of the recipients of the first subset with a recall question inquiring whether each of the recipients in the subset recalls the advertisement;
receiving responses to the recall question from a plurality of the recipients of the first subset; and
selecting responses to the recall question comprising a second subset of recipients, the second subset having a second market segment profile that is approximately the same as the first market segment profile.

15. The method of claim 14, further comprising determining an effectiveness score for the advertisement, the effectiveness score based on a number of recipients in the subset recalling the advertisement.

16. The method of claim 14, wherein the recall question is provided within 24 hours after the plurality of recipients has been provided with the advertisement.

17. The method of claim 14, further comprising determining an effectiveness score for the advertisement, the effectiveness score based on a number of recipients in the subset recalling the advertisement.

18. The method of claim 17, further comprising:
calculating at least two effectiveness scores for each of at least two market segments of the plurality of recipients; and
comparing a first effectiveness score of the advertisement for a first market segment to a second effectiveness score of the advertisement for a second market segment.

19. The method of claim 18, further comprising reallocating a distribution of advertising impressions served from a first market segment having a first effectiveness score to a second market segment having a second effectiveness score higher than the first effectiveness score.

20. The method of claim 18, further comprising comparing a first effectiveness score of the advertisement for a first third party website to a second effectiveness score of the advertisement for a second third party website.

21. The method of claim 18, wherein the effectiveness score is calculated for at least one third party website providing the advertisement to the plurality of recipients, the effectiveness score measuring recall of the advertisement for each of the at least one third party websites.

22. The method of claim 18, wherein the effectiveness score is calculated by multiplying a total number of impressions of the advertisement served by a response rate of the first subset to the recall question.

23. The method of claim 14, further comprising:
receiving the advertisement and a target audience of a defined demographic for the advertisement from an advertiser; and
using an effectiveness score for the defined demographic to further refine the target audience received from the advertiser.

24. The method of claim 14, wherein the market segment information comprises demographic information.

25. The method of claim 14, wherein the market segment information comprises psychographic information.

26. The method of claim 14, wherein the market segment information comprises social object information stored in a social networking system.
